(19) United States
(12) Patent Application Publication
(10) Pub. No.: US 2021/0011143 A1
(43) Pub. Date: Jan. 14, 2021

(54) DISTANCE MEASUREMENT SYSTEM

(71) Applicant: KABUSHIKI KAISHA TOKAI RIKA DENKI SEISAKUSHO, Aichi (JP)

(72) Inventors: Kazuki NAIKI, Aichi (JP); Hiroaki IWASHITA, Aichi (JP); Satoshi MORI, Aichi (JP); Kenichi KOGA, Aichi (JP); Yoshiyuki OYA, Aichi (JP); Masateru FURUTA, Aichi (JP); Masanori KOSUGI, Aichi (JP)

(73) Assignee: KABUSHIKI KAISHA TOKAI RIKA DENKI SEISAKUSHO, Aichi (JP)

(21) Appl. No.: 16/981,339

(22) PCT Filed: Feb. 28, 2019
(86) PCT No.: PCT/JP2019/007832

§ 371 Date: Sep. 16, 2020

(30) Foreign Application Priority Data
Mar. 22, 2018 (JP) 2018-054698
Jul. 27, 2018 (JP) 2018-141392

(51) Int. Cl. G01S 11/02; H04W 48/02

(52) U.S. Cl. CPC G01S 11/02; B60R 25/209; H04W 48/02

(57) ABSTRACT

A distance measurement system includes communication units arranged in a communication subject. The communication units form different radio wave transmission paths in accordance with a location of a communication device, and are configured such that when one of the radio wave transmission paths is blocked, communication with the communication device is enabled by another one of the radio wave transmission paths. The distance measurement system further includes a distance measurement unit that measures the distance between the communication device and the communication subject using one of the radio wave transmission paths by performing distance measurement communication that transfers a distance measurement signal between the communication units and the communication device.

### TECHNICAL FIELD

The present invention relates to a distance measurement system that measures the distance between a communication device and a communication subject.

### BACKGROUND ART

A known electronic key system controls a vehicle through wireless communication between an electronic key carried by a user and an onboard device of the vehicle. A smart verification system is known as an electronic key system in which an electronic key responds automatically to ID verification performed through wireless communication.

With this type of electronic key, unauthorized actions using a relay may be performed to accomplish ID verification when the user who is carrying the authorized electronic key does not intend to do so. One type of an unauthorized action performed with a relay when the electronic key is located, for example, far from a vehicle uses multiple relays to relay communication between an onboard device and the electronic key and accomplish unauthorized ID verification. Thus, ID verification may be accomplished without the user who is carrying the authorized electronic key knowing so.

Patent Document 1 discloses a technique for measuring the distance between a vehicle and an electronic key to detect an unauthorized action that uses the relay. In this case, a distance measurement signal in the ultra-wideband (UWB) is transmitted and received between an onboard device and the electronic key, and the distance measurement signal is analyzed to measure the distance between the vehicle and the electronic key. If a relay is used, the arrival time of the distance measurement signal will be later, and the measured distance will be greater than a threshold value. This allows for detection of an unauthorized action.

### PRIOR ART DOCUMENT

### Patent Document

Patent Document 1: Japanese Laid-Open Patent Publication No. 2014-227647

### SUMMARY OF THE INVENTION

### Problems that the Invention is to Solve

If an obstacle (e.g., body of user) is in a transmission path of a distance measurement signal between an onboard device and an electronic key, the distance measurement signal from the onboard device may fail to reach the electronic key and distance measurement may not be performed. In particular, UWB radio waves, when used as a distance measurement signal, are high in frequency and short in wavelength. Thus, the UWB radio waves may easily be blocked by a human body, and the establishment of distance measurement communication will be hindered depending on the positional relationship between the onboard device and the electronic key. In this manner, distance measurement communication is difficult to establish.

It is an objective of the present invention to provide a distance measurement system that establishes distance measurement communication in an improved manner.

### Means for Solving the Problem

In one aspect, a distance measurement system that measures a distance between a communication device and a communication subject includes communication units arranged in the communication subject, in which the communication units form different radio wave transmission paths in accordance with a location of the communication device, and are configured such that when one of the radio wave transmission paths is blocked, communication with the communication device is enabled by another one of the radio wave transmission paths and a distance measurement unit that measures the distance between the communication device and the communication subject using one of the radio wave transmission paths by performing distance measurement communication that transfers a distance measurement signal between the communication units and the communication device.

With this structure, radio wave transmission paths of a distance measurement signal are formed between the communication device and the communication subject. If one of the radio wave transmission paths is blocked by an obstacle, another one of the radio wave transmission paths is used to establish distance measurement communication. Thus, the distance measurement communication is established in an improved manner.

The distance measurement system preferably includes a communication controller that is configured so as to selectively actuate the communication units, and a communication suspension unit that is configured so as to suspend transmission or reception of the distance measurement signal when the distance measurement communication is established in one of the radio wave transmission paths and does not perform subsequent distance measurement communication.

With this structure, when distance measurement communication is established between one of the communication units and the communication device, subsequent distance measurement communication is not performed. This reduces power consumption.

The distance measurement system preferably includes a locating unit that determines a position of the communication device relative to the communication subject, and the communication controller sets an actuation order of the communication units based on the determination of the locating unit.

With this structure, the communication units that are close to the communication device are actuated to easily establish distance measurement communication. This quickly establishes the distance measurement communication, reduces power consumption, and increases the response speed of the distance measurement communication.

In the distance measurement system, the communication controller preferably limits the communication units that are actuated to only communication units associated with an area in which the communication device is determined to be located.

With this structure, only the communication units necessary for distance measurement are actuated to further reduce power consumption.

The distance measurement system may further include operation units arranged in the communication subject to actuate the communication subject. In this case, when one of the operation units is operated, the communication controller preferably limits the communication units that are actuated to only communication units arranged at positions corresponding to the operated operation unit.

With this structure, only the communication units necessary for distance measurement are actuated when the operation unit is operated, thereby further reducing power consumption.

In the distance measurement system, the communication controller may give priority to and actuate one of the communication units that is associated with an area in which the communication device is determined to be located and actuate other ones of the communication units in a predetermined order.

### Effects of the Invention

The distance measurement system of the present invention establishes distance measurement communication in an improved manner.

### BRIEF DESCRIPTION OF THE DRAWINGS

FIG. 1 is a block diagram showing the structure of a distance measurement system according to one embodiment.

FIG. 2 is a diagram showing an area of LF radio waves formed around a vehicle in the embodiment.

FIG. 3 is a diagram showing a transmission path of UWB radio waves formed around the vehicle in the embodiment.

FIG. 4 is a time chart of distance measurement communication in the embodiment.

FIG. 5 is a time chart of distance measurement communication in the embodiment.

FIG. 6 is a time chart of distance measurement communication according to another embodiment.

FIG. 7 is a block diagram showing the structure of a distance measurement system in another embodiment.

FIG. 8 is a diagram showing a case in which an exterior door handle is operated in another embodiment.

FIG. 9 is a diagram showing a case in which an engine switch is operated in another embodiment.

### EMBODIMENTS OF THE INVENTION

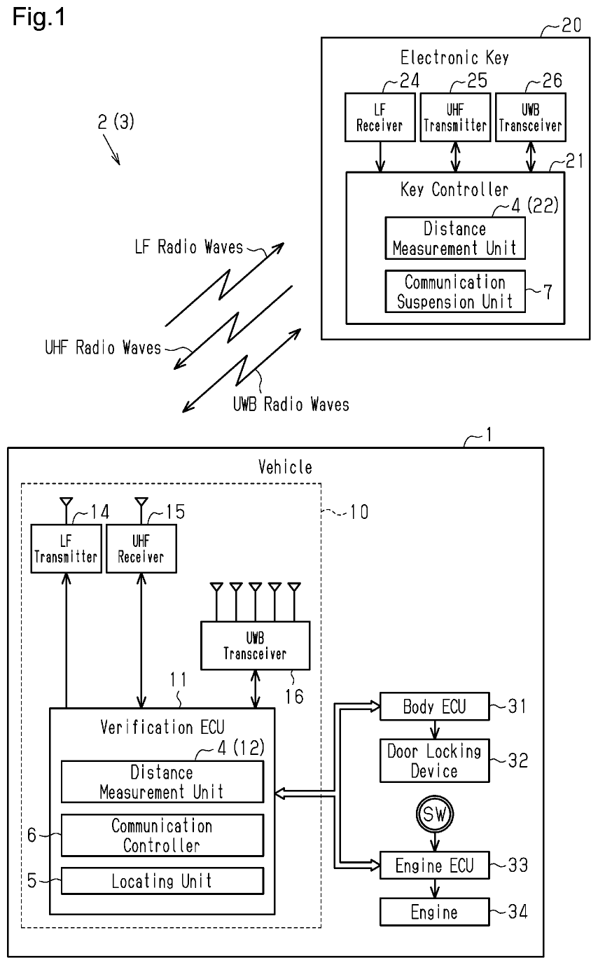

A distance measurement system according to one embodiment will now be described with reference to FIGS. 1 to 5.

As shown in FIG. 1, a vehicle 1 includes a distance measurement system 2 (electronic key system 3 in this example) that verifies the authenticity of an electronic key 20 through wireless communication. The electronic key system 3 includes an onboard device 10 installed in the vehicle 1 and the electronic key 20 carried by a user. The electronic key 20 corresponds to a communication device, and the vehicle 1 corresponds to a communication subject of the communication device.

The vehicle 1 includes a body ECU 31 that is electrically connected to a door locking device 32 to control the locking and unlocking of a door and an engine ECU 33 that starts an engine 34. The body ECU 31 and the engine ECU 33 are electrically connected to the onboard device 10. In the electronic key system 3, a series of ID verification processes are executed automatically through mutual communication between the onboard device 10 and the electronic key 20, and the locking or unlocking of the door and the starting of the engine are permitted or executed on condition that the ID verification is accomplished in an area near the vehicle 1.

The onboard device 10 includes a verification ECU 11 that controls the actuation of the onboard device 10. The onboard device 10, which performs short-range communication, includes a low frequency (LF) transmitter 14 that transmits radio waves in the LF band, an ultra-high frequency (UHF) receiver 15 that receives radio waves in the UHF band, and a UWB transceiver 16 that transmits and receives radio waves in the UWB band. The LF transmitter 14, the UHF receiver 15, and the UWB transceiver 16 are electrically connected to the verification ECU 11. The verification ECU 11 controls the transmission and reception of radio waves. The UWB transceiver 16 corresponds to a communication unit.

The electronic key 20 includes an electronic key controller 21 that controls actuation of the electronic key 20. The electronic key 20 includes an LF receiver 24 that receives LF radio waves, a UHF transmitter 25 that transmits UHF radio waves, and a UWB transceiver 26 that transmits and receives UWB radio waves. The LF receiver 24, the UHF transmitter 25, and the UWB transceiver 26 are electrically connected to the electronic key controller 21. The electronic key controller 21 controls the transmission and reception of radio waves.

When the LF transmitter 14 of the onboard device 10 transmits a wake signal in the LF band, the electronic key 20 receives the wake signal, switches to an activated state, and transmits an acknowledgment signal from the UHF transmitter 25. When the verification ECU 11 receives the acknowledgment signal as a response to the transmitted wake signal, the verification ECU starts ID verification (smart verification). In this case, the verification ECU 11 obtains an electronic key ID, which is registered in the electronic key 20, to verify the electronic key ID and uses an encryption key to execute an authentication process such as challenge-response authentication. When the verification ECU 11 recognizes that the verification and the authentication have been accomplished, the verification ECU 11 determines that the ID verification is accomplished.

The electronic key system 3 includes a distance measurement unit 4 that measures the distance between the onboard device 10 and the electronic key 20 through distance measurement communication using UWB radio waves. The distance measurement unit 4 of the present example includes a distance measurement unit 12 arranged in the onboard device 10 and a distance measurement unit 22 arranged in the electronic key 20. The distance measurement unit 4, for example, transfers a distance measurement signal between the onboard device 10 and the electronic key 20 using UWB radio waves and measures the distance between the onboard device 10 and the electronic key 20 based on a transmission time of the distance measurement signal. The distance measurement unit 4 determines that distance measurement authentication is accomplished if the distance between the two is less than or equal to a threshold value.

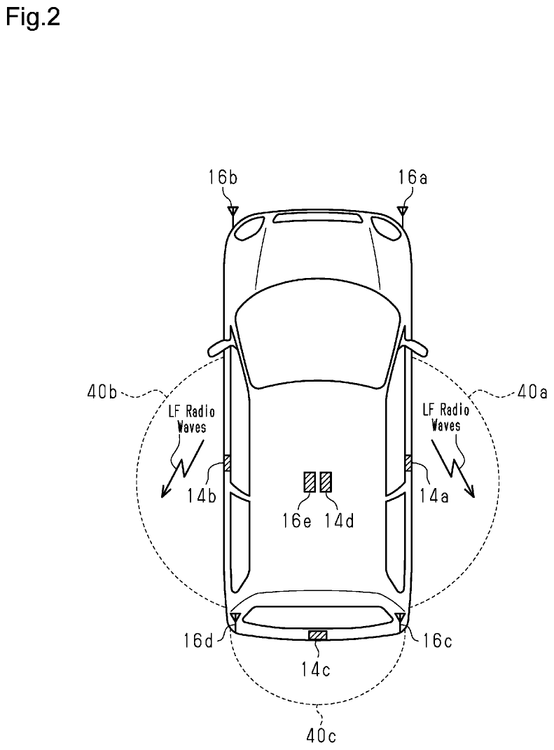

As shown in FIG. 2, the LF transmitter 14 is arranged at multiple positions in the vehicle 1. In the present example, the LF transmitter 14 is arranged at four positions in the vehicle 1 to form multiple communication areas 40 around the vehicle 1. A first LF transmitter 14a is arranged, for example, in the exterior door handle of the door of the driver seat to form a first communication area 40a around the door next to the driver seat. A second LF transmitter 14b is arranged, for example, in the exterior door handle of the door next to the passenger seat to form a second communication area 40b around the door next to the passenger seat. A third LF transmitter 14c is arranged, for example, in a back door to form a third communication area 40c around the back door. A fourth LF transmitter 14d is arranged inside the passenger compartment to form a communication area (not shown) inside the passenger compartment.

When the electronic key 20 enters any one of the communication areas 40 (40a to 40c), the electronic key 20 receives LF radio waves through the LF receiver 24. The electronic key 20 transmits a response signal (UHF radio waves) to the LF radio waves through the UHF transmitter 25. When the verification ECU 11 receives the response signal through the UHF receiver 15, the entrance of the electronic key 20 into any one of the communication areas 40a to 40c is detected. In this manner, the verification ECU 11 has the functionality for finding the area in which the electronic key 20 is located.

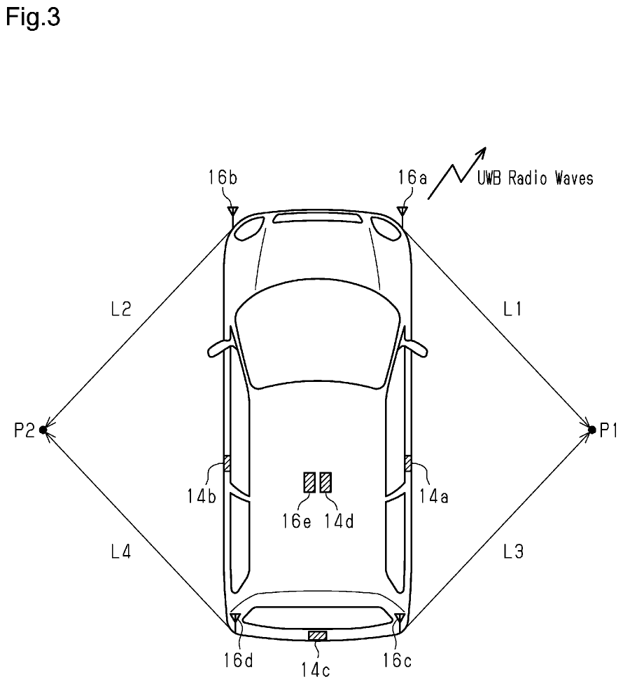

As shown in FIG. 3, the UWB transceiver 16 is arranged at multiple positions in the vehicle 1. In the present example, the UWB transceiver 16 is arranged at five positions in the vehicle 1. A first UWB transceiver 16a is arranged at the corner of the vehicle 1 located frontward from the driver seat to transmit UWB radio waves frontward from the vehicle 1 and toward the driver seat. A second UWB transceiver 16b is arranged at the corner of the vehicle 1 located frontward from the passenger seat to transmit UWB radio waves frontward from the vehicle 1 and toward the passenger seat. A third UWB transceiver 16c is arranged at the corner of the vehicle 1 located rearward from the driver seat to transmit UWB radio waves rearward from the vehicle 1 and toward the driver seat. A fourth UWB transceiver 16d is arranged at the corner of the vehicle 1 located rearward from the passenger seat to transmit UWB radio waves rearward from the vehicle 1 and toward the passenger seat. A fifth UWB transceiver 16e is arranged inside the passenger compartment to transmit UWB radio waves inside the passenger compartment.

The UWB transceiver 16 forms radio wave transmission paths L with the electronic key 20 outside the passenger compartment. If the electronic key 20 is located at a predetermined point P1 that is close to the driver seat outside the passenger compartment, a radio wave transmission path L1 is formed between the electronic key 20 and the first UWB transceiver 16a, and a radio wave transmission path L3 is formed between the electronic key 20 and the third UWB transceiver 16c.

If the electronic key 20 is located at a predetermined point P2 that is close to the passenger seat, a radio wave transmission path L2 is formed between the electronic key 20 and the second UWB transceiver 16b, and a radio wave transmission path LA is formed between the electronic key 20 and the fourth UWB transceiver 16d.

Returning to FIG. 1, the distance measurement system 2 (verification ECU 11) includes a locating unit 5 that determines which one of the communication areas 40 (40a to 40c), formed through short-range communication of LF radio waves, the electronic key 20 is located in. The locating unit 5 recognizes the one of the communication areas 40 in which communication with the electronic key 20 has been established as the area in which the electronic key 20 is located.

The distance measurement system 2 (verification ECU 11) includes a communication controller 6 that controls radio wave transmission of the UWB transceiver 16 (actuation of UWB radio wave transmission). The communication controller 6 in the present example sets the order in which the UWB transceivers 16 (16a to 16e) are activated based on the locating result of the locating unit 5 to selectively actuate the UWB transceivers 16. In this manner, in the present example, the communication controller 6 sets the actuation order of the UWB transceivers 16 in accordance with the one of the communication areas 40a to 40c that the electronic key 20 has entered.

The distance measurement system 2 (electronic key controller 21) includes a communication suspension unit 7 that suspends distance measurement communication from when distance measurement communication is established. The communication suspension unit 7 of the present example suspends the transfer of a distance measurement signal and does not perform distance measurement communication from when distance measurement communication is established in one of the radio wave transmission paths L. In the present example, the communication suspension unit 7 suspends reception of a distance measurement signal by the electronic key 20 when distance measurement communication is established with one of the UWB transceivers 16.

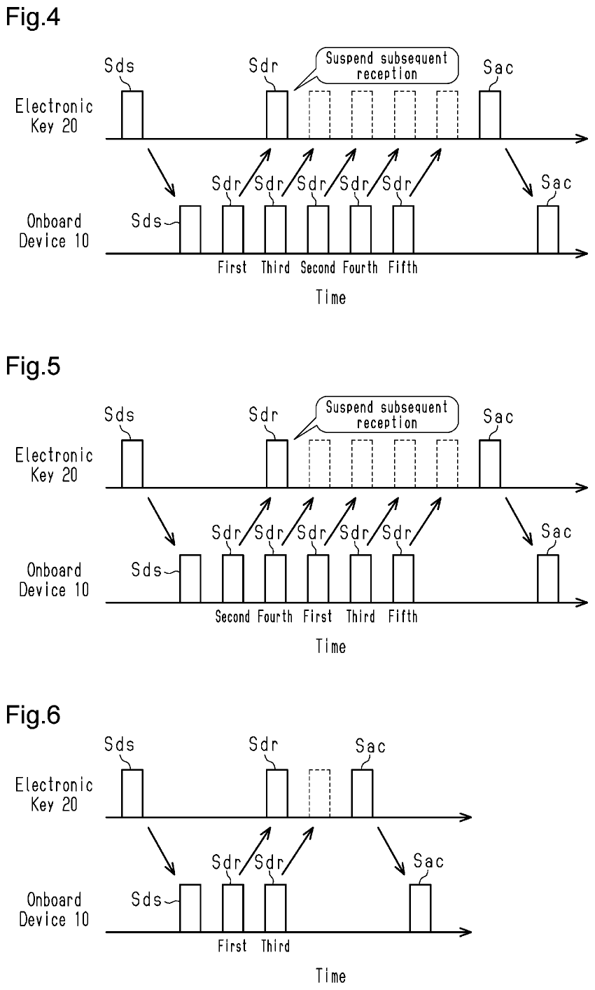

A procedure for performing distance measurement communication with the electronic key system 3 will now be described with reference FIG. 4. In this case, it is assumed that a user carrying the authorized electronic key 20 will enter the first communication area 40a and unlock the door next to the driver seat. The locating unit 5 detects that the electronic key 20 has entered the first communication area 40a through communication between the onboard device 10 and the electronic key 20 with LF radio waves and UHF radio waves. When smart verification is accomplished through LF-UHF communication between the onboard device 10 and the electronic key 20, the process proceeds to distance measurement communication.

As shown in FIG. 4, in the distance measurement communication, the distance measurement unit 22 of the electronic key 20 transmits a distance measurement start signal Sds (in UWB band) through the UWB transceiver 26. The distance measurement unit 12 of the onboard device 10 receives the distance measurement start signal Sds through the UWB transceiver 16 and transmits a distance measurement response signal Sdr (in UWB band). The distance measurement start signal Sds and the distance measurement response signal Sdr correspond to a distance measurement signal.

The communication controller 6 sets the actuation order of the UWB transceivers 16a to 16e that transmit radio waves based on the locating result of the locating unit 5. In the present example, the electronic key 20 is in the first communication area 40a. Thus, the communication controller 6 gives priority to the actuation of the first UWB transceiver 16a and the third UWB transceiver 16c that are close to the first communication area 40a. The transmission order of distance measurement response signals Sdr is set in the order of the first UWB transceiver 16a, the third UWB transceiver 16c, the second UWB transceiver 16b, the fourth UWB transceiver 16d, and the fifth UWB transceiver 16e.

The electronic key 20 is in the first communication area 40a. Thus, the distance measurement response signal Sdr transmitted from the first UWB transceiver 16a reaches the electronic key 20 without being blocked by an obstacle or the like. When the distance measurement unit 22 of the electronic key 20 receives the distance measurement response signal Sdr from the first UWB transceiver 16a through the UWB transceiver 26, the distance measurement unit 22 analyzes the distance measurement response signal Sdr to calculate the distance between the vehicle 1 and the electronic key 20. In this case, the distance between the two is close enough, and distance measurement authentication is accomplished.

When distance measurement communication is established (distance measurement authentication is accomplished in the present example), the communication suspension unit 7 of the electronic key 20 has the UWB transceiver 26 suspend subsequent reception of radio waves. Thus, when the UWB transceivers 16 of the onboard device 10 subsequently transmit distance measurement response signals Sdr, the electronic key 20 will not receive the distance measurement response signals Sdr. Specifically, the third UWB transceiver 16c, the second UWB transceiver 16b, the fourth UWB transceiver 16d, and the fifth UWB transceiver 16e of the vehicle 1 transmit distance measurement response signals Sdr in this order. However, the electronic key 20 will not receive the signals.

The distance measurement unit 22 of the electronic key 20 transmits a response signal Sac (in UHF band) indicating that the distance measurement communication has been established. When the distance measurement unit 12 of the onboard device 10 receives the response signal Sac through the UHF receiver 15, the distance measurement unit 12 recognizes the accomplishment of the distance measurement authentication and allows ID verification (smart verification) to be accomplished. When the ID verification (smart verification) is accomplished, the unlocking of the door is permitted or executed.

In the present example, the electronic key 20 receives the radio waves of the first UWB transceiver 16a. However, if there is a blocking object (such as human body) between the first UWB transceiver 16a and the electronic key 20 and distance measurement communication is not established, the electronic key 20 will continue to receive UWB radio waves. In this case, the electronic key 20 is close to the driver seat (first communication area 40a). Thus, distance measurement communication will likely be established by the third UWB transceiver 16c. Thus, even if the electronic key 20 cannot receive the radio waves of the first UWB transceiver 16a, the electronic key 20 will receive the radio waves of the third UWB transceiver 16c and allow distance measurement authentication to be accomplished.

If the electronic key 20 is far from the vehicle 1 and a relay or the like is used to establish unauthorized communication, the distance between the vehicle 1 and the electronic key 20 will exceed a threshold value during distance measurement authentication. Thus, if the distance measurement unit 22 of the electronic key 20 analyzes the distance measurement response signal Sdr from the first UWB transceiver 16a and determines that the distance between the vehicle 1 and the electronic key 20 exceeds the threshold value, the distance measurement communication will not be suspended and will be continued. If the distance measurement unit 22 of the electronic key 20 determines that the distance between the vehicle 1 and the electronic key 20 obtained from the distance measurement response signal Sdr of each of the UWB transceivers 16a to 16e all exceed the threshold value, the distance measurement unit 22 transmits a response signal Sac indicating that distance measurement authentication is unaccomplished. In this case, ID verification is unaccomplished.

Distance measurement communication when the electronic key 20 enters the second communication area 40b in the electronic key system 3 will now be described with reference to FIG. 5. Events that occur in the same manner as when the electronic key 20 enters the first communication area 40a will not be described.

As shown in FIG. 5, the communication controller 6 of the onboard device 10 actuates the UWB transceivers 16a to 16e in the order of the second UWB transceiver 16b, the fourth UWB transceiver 16d, the first UWB transceiver 16a, the third UWB transceiver 16c, and the fifth UWB transceiver 16e. That is, the communication controller 6 actuates the UWB transceivers 16 while giving priority to the UWB transceivers 16 that are close to the second communication area 40b. If the distance measurement unit 22 of the electronic key 20 determines that distance measurement communication is established, the communication suspension unit 7 has the UWB transceiver 26 suspend subsequent reception of radio waves.

In the present example, multiple radio wave transmission paths are formed between the onboard device 10 and the electronic key 20 to increase the probability of distance measurement communication being established.

If distance measurement communication is established between one of the UWB transceivers 16 and the electronic key 20, the communication suspension unit 7 of the electronic key 20 has UWB transceiver 26 suspend subsequent reception of radio waves. Thus, the electronic key 20 does not have to perform communication with all of the UWB transceivers 16. This limits increases in power consumption.

The communication controller 6 of the onboard device 10 is configured to determine the actuation order of the UWB transceivers 16 based on the area where the electronic key 20 is located in (communication area 40), which is detected by the verification ECU 11. Thus, the communication controller 6 actuates the UWB transceivers 16 while giving priority to the UWB transceivers 16 that are likely to establish distance measurement communication. Thus, distance measurement communication is quickly completed. This reduces power consumption and increases the speed of distance measurement communication.

The present embodiment may be modified as follows. The present embodiment and the following modifications can be combined as long as the combined modifications are not in contradiction.

In the present embodiment, the communication controller 6 may limit the UWB transceivers 16 that are actuated to only those associated with the communication area 40 in which the electronic key 20 is located. The processing procedure, in this case, will now be described with reference to FIG. 6. In this case, it is assumed that the electronic key 20 has entered the first communication area 40a.

As shown in FIG. 6, the communication controller 6 of the onboard device 10 determines that the electronic key 20 is in the first communication area 40a and actuates the first UWB transceiver 16a and the third UWB transceiver 16c that are close to the first communication area 40a but does not actuate the other UWB transceivers 16. The actuation order of the actuated UWB transceiver 16 may be set in any manner. In the present example, the UWB transceivers 16 are actuated in the order of the first UWB transceiver 16a and the third UWB transceiver 16c. The second UWB transceiver 16b, the fourth UWB transceiver 16d, and the fifth UWB transceiver 16e are not actuated. In this case, the probability is also high that distance measurement communication will be established by the first UWB transceiver 16a or the third UWB transceiver 16c. Since the UWB transceivers 16 actuated in the onboard device 10 are limited, power consumption will be reduced.

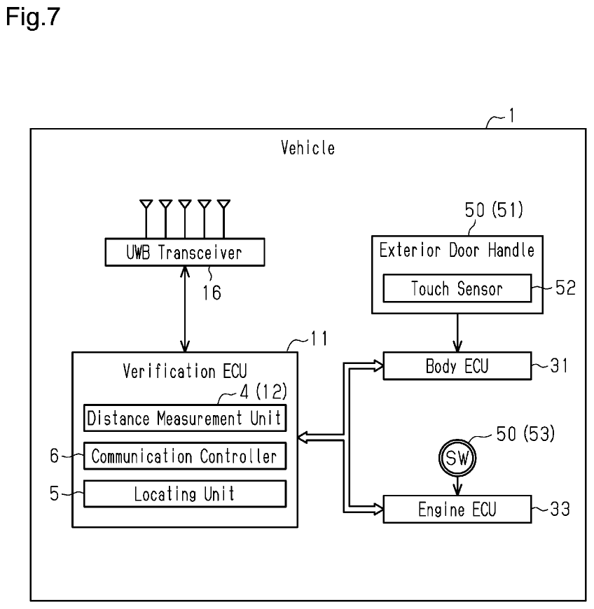

In the present embodiment, the actuated UWB transceivers 16 are not limited to those that correspond to the communication area 40 that the electronic key 20 has entered. For example, the vehicle 1 may include operation units 50, each actuating the UWB transceivers 16 located at corresponding positions when operated. The processing procedure, in this case, will now be described with reference to FIGS. 7 to 9.

As shown in FIG. 7, the operation unit 50 includes an exterior door handle 51 arranged on the door of the vehicle 1 and an engine switch 53 arranged inside the passenger compartment. The exterior door handle 51, which is operated to open and close the door, includes a touch sensor 52 that detects touching of the exterior door handle 51. The engine switch 53 is, for example, a push switch that is operated to switch the state of the engine 34. The locating unit 5 of the present example determines the location of the electronic key 20 based on the operation of the operation unit 50, which is arranged on the vehicle 1.

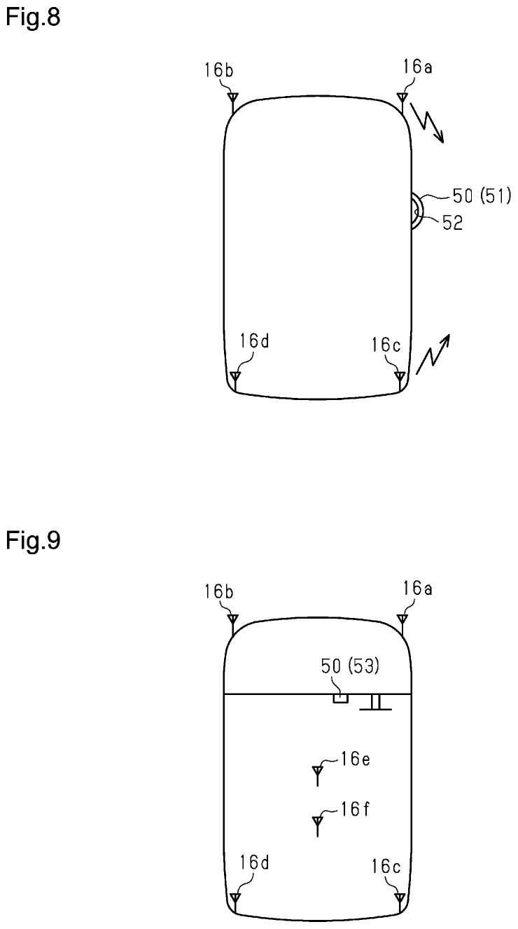

As shown in FIG. 8, for example, when the exterior door handle 51, which is arranged on the door next to the driver seat of the vehicle 1, is operated, the touch sensor 52 detects touching of the exterior door handle 51 and outputs a detection signal. The locating unit 5 recognizes the location of the electronic key 20 based on the detection signal of the touch sensor 52. That is, the locating unit 5 determines that the electronic key 20 is located near the door next to the driver seat. In this case, the communication controller 6 actuates the first UWB transceiver 16a and the third UWB transceiver 16c that are close to the door next to the driver seat and does not actuate the other UWB transceivers 16.

In an example shown in FIG. 9, a sixth UWB transceiver 16f is arranged in the passenger compartment in addition to the fifth UWB transceiver 16e. As shown in FIG. 9, when the engine switch 53 is operated, the locating unit 5 determines that the electronic key 20 is inside the passenger compartment. In this case, the communication controller 6 actuates the fifth UWB transceiver 16e and the sixth UWB transceiver 16f that are arranged inside the passenger compartment and does not actuate the other UWB transceivers 16 that are arranged outside the passenger compartment.

With a structure such as that described above, when the user carrying the electronic key 20 operates the operation unit 50, the UWB transceivers 16 suited for the location of the electronic key 20 are selectively actuated. This easily establishes distance measurement communication. When the actuation order of the UWB transceivers 16 (communication units) is set in this manner based on the locating result of the locating unit 5, there is no particular limitation to the configuration for determining the position of the electronic key 20 (communication device) relative to the vehicle 1 (communication subject) as long as the area in which the electronic key 20 is located can be determined.

In the present embodiment, the communication suspension unit 7 may be arranged in the onboard device 10. When a distance measurement response signal Sdr is transmitted from the onboard device 10 through the UWB transceiver 16, the communication suspension unit 7 may suspend the transmission of the a distance measurement response signal Sdr in response to a response signal Sac from the electronic key 20. This reduces power consumption. In this manner, the communication suspension unit 7 may function to suspend the transmission or reception of a distance measurement signal during distance measurement communication.

In the present embodiment, the establishment of distance measurement communication is determined when distance measurement authentication is accomplished. However, this is not a limitation. Establishment of distance measurement communication may be determined when the electronic key 20 receives a distance measurement signal. Further, a parameter such as the intensity of a received distance measurement signal may be used as criteria for determination.

In the present embodiment, the number and the positions of the UWB transceivers 16 of the onboard device 10 are not limited as long as different transmission paths can be formed with the electronic key 20 outside the passenger compartment. The UWB transceivers 16 may be mounted at, for example, positions near open space that will not be blocked by components of the vehicle 1 such as a pillar, a mirror or the like of the vehicle 1.

In the present embodiment, the method for distance measurement communication is not limited. The distance may be measured using parameters such as the intensity of a received distance measurement signal, arrival time, phase, and the like. A distance measurement start signal Sds and a distance measurement response signal Sdr may be transmitted from any one of the onboard device 10 and the electronic key 20, and three or four messages may be exchanged.

The functionality for determining the communication area 40 in which the electronic key 20 is located and selectively actuating the UWB transceivers 16 associated with the area may be omitted from the distance measurement system 2 of the present example.

In the present embodiment, there is no limit to the bandwidth of wireless communication between the onboard device 10 and the electronic key 20 for ID verification. The communication method may also be modified in various manners.

In the present embodiment, distance measurement does not have to use UWB radio waves. For example, time of flight (ToF), received signal strength indication (RSSI), or the like may be applied to communication protocols such as Bluetooth (registered trademark) or Wi-Fi (registered trademark) for distance measurement.

In the present embodiment, the electronic key 20 may be a high-performance mobile phone such as a smartphone.

In the present embodiment, the electronic key system 3 is not limited to a system in which the electronic key 20, when receiving LF radio waves periodically transmitted from the vehicle 1, transmits the electronic key ID in the UHF band for verification. The system may be any system that wirelessly determines the authenticity of the electronic key 20.

In the present embodiment, the distance measurement system is not limited to use with a vehicle. The distance measurement system may be used to lock or unlock the door of a house.

1. A distance measurement system that measures a distance between a communication device and a communication subject, the distance measurement system comprising:
communication units arranged in the communication subject, wherein the communication units form different radio wave transmission paths in accordance with a location of the communication device, and are configured such that when one of the radio wave transmission paths is blocked, communication with the communication device is enabled by another one of the radio wave transmission paths; and
a distance measurement unit that measures the distance between the communication device and the communication subject using one of the radio wave transmission paths by performing distance measurement communication that transfers a distance measurement signal between the communication units and the communication device.

2. The distance measurement system according to claim 1, further comprising:
a communication controller that is configured so as to selectively actuate the communication units; and
a communication suspension unit that is configured so as to suspend transmission or reception of the distance measurement signal when the distance measurement communication is established in one of the radio wave transmission paths and does not perform subsequent distance measurement communication.

3. The distance measurement system according to claim 2, further comprising:
a locating unit that determines a position of the communication device relative to the communication subject, wherein the communication controller sets an actuation order of the communication units based on the determination of the locating unit.

4. The distance measurement system according to claim 3, wherein the communication controller limits the communication units that are actuated to only communication units associated with an area in which the communication device is determined to be located.

5. The distance measurement system according to claim 3, further comprising:
operation units arranged in the communication subject to actuate the communication subject, wherein when one of the operation units is operated, the communication controller limits the communication units that are actuated to only communication units arranged at positions corresponding to the operated operation unit.

6. The distance measurement system according to claim 3, wherein the communication controller gives priority to and actuates one of the communication units that is associated with an area in which the communication device is determined to be located and actuates other ones of the communication units in a predetermined order.
